(19) United States
(12) Patent Application Publication
(10) Pub. No.: US 2003/0009439 A1
(43) Pub. Date: Jan. 9, 2003

(54) Family tree website architecture

(76) Inventor: Yong Tuck Lee, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/039,795

(22) Filed: Oct. 19, 2001

Related U.S. Application Data
(60) Provisional application No. 60/242,381, filed on Oct. 19, 2000.

(51) Int. Cl. G06F 7/00

(52) U.S. Cl. 707/1

(57) ABSTRACT

A method for storing contact information having the steps of storing in a database information about a plurality of groups; storing in a database information about a contact that is a member of at least one of the plurality of groups; linking the stored information about a contact to at least one of the plurality of groups; receiving a request for stored information about a contact from a user; and providing stored information about a contact in response to the request for stored information about a contact. A group name and a group number is stored for each of the plurality of groups. A group number of which the contact is a member and a contact number of the contact is stored. At least one of the group consisting of a telephone number and an e-mail address is stored for the contact. Requests for stored information include the group number of the desired contact and the contact number of the desired contact.

### CROSS-REFERENCE TO RELATED APPLICATION

The present invention claims priority of U.S. provisional application No. 60/242,381, filed on Oct. 19, 2000, entitled FAMILY TREE WEBSITE ARCHITECTURE, the entire contents of which are hereby incorporated herein by reference.

### BACKGROUND OF THE INVENTION

The present invention relates to a structure for websites, and, more particularly, to a structure for organizing contact information based upon association.

The use of handheld organizers either as stand alone devices, or built into portable communication devices, to store telephone numbers has become popular. There are disadvantages to using handheld organizers to store telephone numbers and other contact information, because a person who forgets or loses their handheld organizer is unable to access all of the information stored on the organizer. Additionally, if something happens to the handheld organizer or cellular telephone having stored contact information, that information may be lost.

Moreover, as people acquire multiple phone lines, mobile phones, fax machines, and multiple e-mail accounts, it becomes difficult to organize and access all of the different contact information for a given person. Often a user has to look up the name of a contact and then carefully dial in one of several different phone numbers of the contact to initiate a telephone call. This can often be a difficult and time consuming process fraught with errors. There is therefore a need for a way of enabling someone to maintain a contact list that is not dependent upon portable hardware. Moreover, there is also a need for an organizational system that eases the finding of contact information and the process of communicating with a contact.

### SUMMARY OF THE INVENTION

According to an exemplary embodiment, the present invention is directed to a system and method for organizing contacts in a hierarchical database, where the storage of the database is not dependent upon portable hardware. In an exemplary embodiment, a method for storing contact information has the steps of storing information about one or more groups in a database. Also stored in the database, is information about a contact that is a member of at least one of the groups. Each contact is linked to at least one group. A request for stored information about a contact is received from a user. In response to the request, stored information about a contact is provided to a user.

The step of storing information about one or more groups includes storing a group name for each group, and storing a group number for each group. The step of storing information about a contact includes storing a group number of which the contact is a member, storing a contact number for the contact, and storing a telephone number and/or an e-mail address for the contact. Several telephone numbers and an e-mail address may be stored for each contact.

When a request for stored information is received, the request includes the group number of the desired contact and a contact number of the desired contact. Once a request is received, the database is searched for a contact having the received group number and the received contact number. Once a record is found in the database, a telephone number and/or an e-mail address for the contact found in the database having the received group number and the received contact number is provided.

In an additional embodiment, the user is connected by telephone to the contact identified by group number and by contact number. In another embodiment, an audio message is received from the user and is sent to the contact identified by group number and by contact number via e-mail information stored for the contact. In yet another embodiment, a video message is received from the user and is sent to the contact identified by group number and by contact number via e-mail information stored for the contact.

In an embodiment, a user is authenticated before they can submit group and contact information. The group and contact information is stored in reference to the authenticated user's information. Likewise, a user must be authenticated before making a request for contact information. Once authenticated, and after the user has requested contact information by group number and contact number, the database is searched based upon the user's information, the group number and the contact number.

A system for storing contact information for a user has a database coupled to a computer network for storing information about at least one group and about at least one contact within the at least one group. A server is also coupled to the computer network. The server is configured to receive group information and contact information from the user, and to store the group information and the contact information received from the user in the database. A telephone is connected to a telecommunications network for communicating with a contact. The telephone is coupled to the server through the telecommunications network. The server is further configured to receive a request for contact information from the user using a telephone and to provide the user with contact information.

In an additional embodiment, the server is configured to arrange a telephonic link between the user on the telephone and a contact in response to a user request for contact information. In another embodiment, the server is configured to receive an audio message from the user; and to send the audio message to a contact over the computer network using e-mail information stored for the contact.

### BRIEF DESCRIPTION OF THE DRAWINGS

These and other features, aspects, and advantages of the present invention will become better understood with regard to the following description, appended claims, and accompanying drawings wherein:

FIG. 1 is a block diagram of a system using a family tree website architecture in accordance with one embodiment of the present invention;

FIG. 2 is an overview of the hardware used with a family tree website architecture according to an embodiment of the present invention;

FIG. 3 is a schematic diagram showing an address book structure according to an embodiment of the present invention;

FIG. 4 is a group of contact database records according to an embodiment of the present invention;

FIG. 5 is a flow chart showing user authentication according to an embodiment of the present invention;

FIG. 6 is a web page showing a contact addition and organization screen according to an embodiment of the present invention;

FIG. 7 is a web page showing a contact group addition screen according to an embodiment of the present invention;

FIG. 8 is a web page showing a contact addition and organization screen with an additional group of contacts added according to an embodiment of the present invention;

FIG. 9 is a web page showing contact information editing screen for a contact within an existing group according to an embodiment of the present invention;

FIG. 10 is a web page showing the result of error checking on the information entered for a contact according to an embodiment of the present invention;

FIG. 11 is a web page showing a contact addition and organization screen where the members of one of the contact groups are visible according to an embodiment of the present invention;

FIG. 12 is a web page showing a contact information editing screen for an existing contact according to an embodiment of the present invention;

FIG. 13 is a web page showing a contact deletion confirmation screen according to an embodiment of the present invention;

FIG. 14 is a web page showing a confirmation screen for the deletion of a group having contacts within it according to an embodiment of the present invention;

FIG. 15 is a flowchart showing a process for a speed dialing system according to an embodiment of the present invention; and

FIG. 16 is a flowchart showing a process for sending a voice message via e-mail according to an embodiment of the present invention.

### DETAILED DESCRIPTION OF THE INVENTION

The detailed description set forth below, in connection with the appended drawings, is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

The present invention discloses a user-friendly framework that facilitates the management of diverse sources and destinations of information. The present invention also improves the organization and efficiency of telecommunication information processing. The foundation of this framework is the use of a “family-tree” (stratified connection hierarchy) to organize the flow and direction of information between a user, and an individual or other entity. The type of information adaptable to this framework includes, but is not limited to, voice messages, facsimile messages, audio text files, video files, and electronic mail. The disclosed framework aggregates and organizes this information into relational databases, which are pre-determined classifications of the recipients of the information, which can be used to redirect the information to other databases via the Internet, and via wireless and wired communication transport systems.

The informational family-tree is organized as a series of groups of possible destinations and interests such as individuals, families, companies, restaurants, etc. Each of these groups contains a list of individuals or entities with their applicable contact information such as electronic mail addresses, telephone, mailing address, facsimile number, and possible preferences. Users may access information from, or to, the individuals or entities within each applicable list. Additionally, users may access or transfer other types of information such as facsimiles, electronic mail, etc., to or from the various groups by using the same family-tree hierarchy.

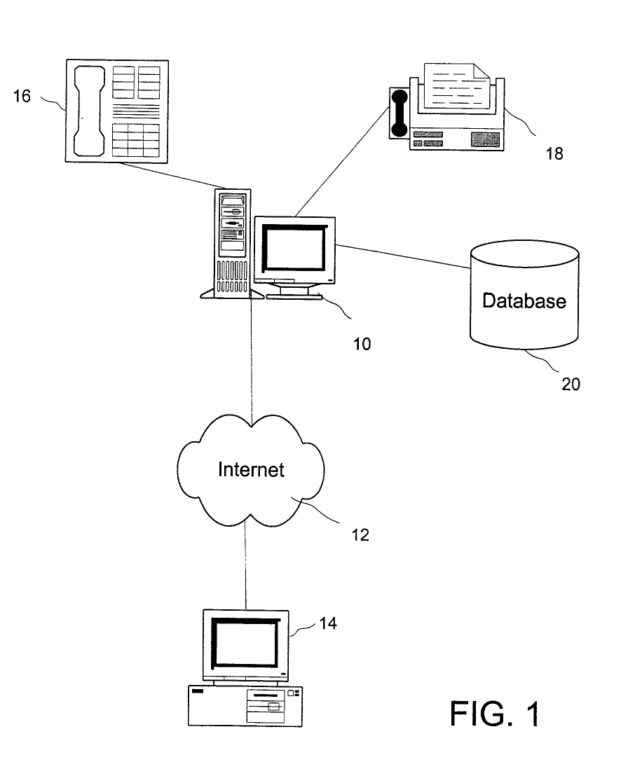

A system employing a family tree architecture in accordance with an exemplary embodiment of the present invention is illustrated in FIG. 1. As shown in FIG. 1, the creation and use of the family tree structure involves a server 10 coupled to a remote communication interface 12. A user may use a computer 14 to access the server via the remote communication interface 12. A user may also communicate with the server 10 via a telephone 16. Additionally, a user may send traditional mail to the organization responsible for the management of the information family-tree on the server 10. The server 10 may contact one or more receivers on a computer 14, on a telephone 16, and via a fax machine 18. The server can also communicate with other servers and with databases 20 to retrieve information.

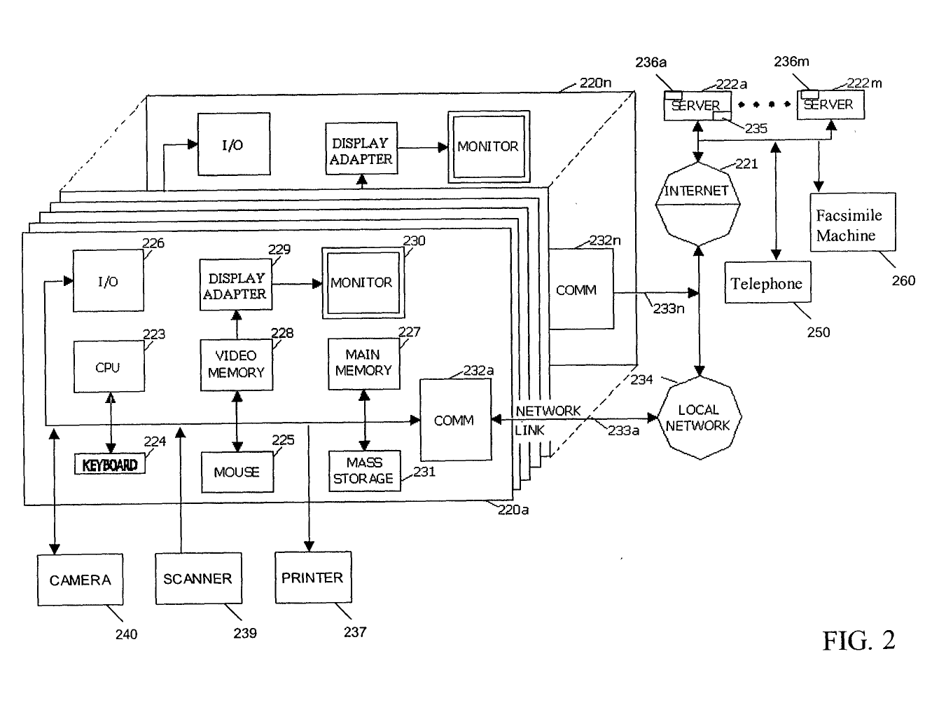

FIG. 2 shows possible hardware of the present system in more detail. The system of FIG. 2 has multiple user devices 220a-220n coupled to servers 222a-222m through one or more remote communication interfaces. In the embodiment described, the remote communication interface comprises the Internet, although in alternative embodiments, the remote communication interface comprises an Intranet or other computer to computer interface.

The Internet has recently been popularized by the rapid success of the World Wide Web (WWW or Web). The Web links together a variety of computers from around the world and various topics in a non-sequential web of associations which permit a user to browse from one topic to another, regardless of the format and order of topics. Users access and browse the Web using a web browser that generally resides and is executed on the user's computer. Commercially available web browsers such as Netscape's Navigator™ and Microsoft Internet Explorer™ are very common and accessible by personal computer (PC) users. The web browser allows a user to retrieve and render hyper-media content from the network of computers within the Web, including text, sound, video and other types of data. This hyper-media content is stored on different web sites.

Web sites are locations on server computers that are accessible through the Internet. A variety of information, such as hyper media contents and databases can be stored on a web site and can be accessed by users with computers connected to the Internet. One of the applications of the Web is its capability to link a web site with a database so that users can search for information. In essence, the web site becomes the user interface (UI) for database applications enabling a user to select search criteria and execute searches of a database that resides on a remote computer. To serve up pages, web sites need a server (a host computer) and server software that runs on the server. The host computer manages the communication protocols and houses the pages and related software required to create a web site on the Internet. Host computers spread throughout the Internet can house different web sites.

The Internet works based on a client/server model. In this model, a client computer communicates with a server computer on which information resides and the client computer depends on the server to deliver requested information and services. These services may involve searching for information and sending it back to the client, such as when a database on the Web is queried. Other examples of these services are delivering web pages through a web site, and handling incoming and outgoing e-mail. Typically, the client is a PC user using a browser to connect to and search the servers. The servers (also known as hosts) are usually more powerful computers that house the data and databases. The client/server model enables the Web to be conceived of as a limitless file storage medium distributed among thousands of host computers, all accessible by any individual PC user.

The web site and the hosts that make up the World Wide Web need to have unique locations so that a client computer can locate and retrieve information and web pages. For example, the unique identifier for a host computer is called an IP (Internet Protocol) address and the unique identifier for a web site (web page) is called the URL (Uniform Resource Locator). A URL indicates where the host computer is located, the location of the web site on the host, and the name of the web page and the file type of each document among other information.

Home and small business users connect to the Internet through Internet service providers using modems and common telephone or cable networks. Wireless and satellite connections are also possible. Larger businesses typically obtain access to the Internet through their private computer networks, using appropriate safeguards to prevent unauthorized access by outside parties to a company's private network.

FIG. 2 shows a block diagram of a typical Internet client/server environment used by the users and servers in one embodiment of the present invention. User devices 220a-220n used by the users are connected to the Internet 221 through communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by the user devices 220a-220n. In one embodiment of the present invention, databases for storing contact information reside on at least one of the servers 222a-222m and are accessible by users using one or more of the user devices 220a-220n to obtain contact information.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a video amplifier 229 under the control of the CPU 223. A communication device 232, such as a modem, provides access to the Internet 221. Optionally, one or more of user devices 220a-220n may be connected to a local network 234. An Input/Output (I/O) device 226 reads data from various data sources and outputs data to various data destinations.

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 236a-236m, such as a hard disk, a CD drive, or a DVD for loading computer software.

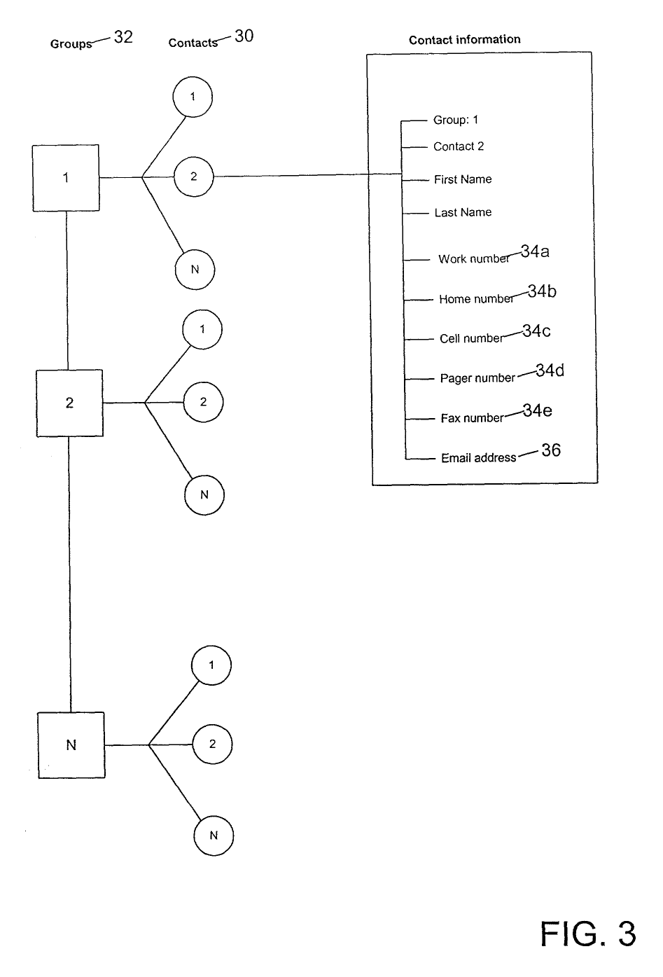

When software, such as the software responsible for executing the processes in FIGS. 3-14 is loaded on the server 222a, an off-the-shelf web management software or load balancing software may distribute the different modules of the software to different servers 222a-222m. A server may utilize an operating system such as DOS, Microsoft Windows, or Linux. The server may use off the shelf, or open source software to generate and serve web pages. In an embodiment, the server uses Apache to generate and serve web pages. The page generating software generates web pages that have, for example, hypertext markup language (HTML) and Javascript components. Additionally, the server may be protected from unauthorized access by the use of a firewall, such as one produced by Checkpoint.

Therefore, in one embodiment, the computer program responsible for executing the present invention resides on one or more servers. Databases to carry out the processes of FIGS. 3 to 12 may be created, maintained and edited in many different types of database software including Microsoft Access, Microsoft FoxPro, and Oracle. In one embodiment of the present invention the database software is Oracle 8.x.

An exemplary web site location 235 is shown on server 222a in FIG. 2. The web site 235 is the user interface for accessing the database described below. The web site 235 has a unique address that is used by the users to access server 222a (in this example) and the web site location on the server 222a. The computer software for executing the processes of the present invention may also reside on the web site 235.

Additionally, the server 222a may be configured to answer a traditional telephone 260 and be programmed to interpret traditional telephone button tones. Moreover, the server 222 may be configured with a modem for communicating with a facsimile machine 270 over traditional telephone lines.

In an exemplary embodiment of the present invention, the family structure is applicable to pre-paid calling card services. Typically in pre-paid calling card services, a user purchases basic telephone voice service on a pre-paid basis, using a credit card, via the telephone service provider's Internet Home Page. Once the user signs up for the prepaid phone service, the user is assigned an account number and given a personal identification number (PIN).

The user typically uses a prepaid phone service by calling a local access number and entering their PIN followed by the telephone number of the person or business that the user desires to contact. A prepaid telephone service typically has the advantage that all telephone call information is available to a user via the telephone service provider's Internet Home Page. The available telephone call information typically includes, the originating phone number, destination phone number, call duration, cost of the call and remaining balance of time on the prepaid phone service.

By integrating the features of the present invention with a basic pre-paid telephone voice service, an integrated web-based interface allows users to intuitively and efficiently manage communications via voice, e-mail, facsimile, and other transmission mediums, to and from a large number of parties.

A family tree structure in the pre-paid telephone service has an online address book that groups contact information (such as telephone, facsimile, cellular telephone numbers and e-mail addresses) according to commonalities such as family, friends, or a company that all of the contacts work for, as determined by a user. A family tree structure supports features such as speed dial, facsimile, multimedia files and voice messages to e-mail addresses through prepaid phone services.

In an exemplary embodiment of the present invention, shown in FIG. 3, a user stores up to 81 contacts 30, by creating up to nine Groups 32 with up to nine Contacts 30 in each group. However, as will be appreciated by those skilled in the art, the number of contacts 30 in the family tree is not limited, and the number of contacts 30 may be expanded when needed.

Each contact 30 in the family tree may be distinguished by a two-digit code. The first digit of the two-digit code is the number of the one of nine groups that the user may create. In an exemplary embodiment, the first digit of the code is from 1 to 9, because each of those numbers is easily reached on a telephone. The second digit of the code is the one of nine contacts 30 within each group 32 that a user may create. Likewise, in an exemplary embodiment, the number of the contacts within a group will be from 1 to 9, which are numbers easily reached on a telephone. It will be appreciated by those skilled in the art that the user may use a code greater than two digits to access more than nine groups and to access contacts in groups containing more than nine contacts.

For each contact 30, the user may store up to five phone numbers 34a-e, one e-mail address 35 and other contact information 36. The web interface allows users to assign a telephone type for each phone number. For example, home, cell, office, pager or other phone or communication addressable service or device. As long as valid information is entered, it will be stored in a database according to the user's account number, as well as the group code and contact code.

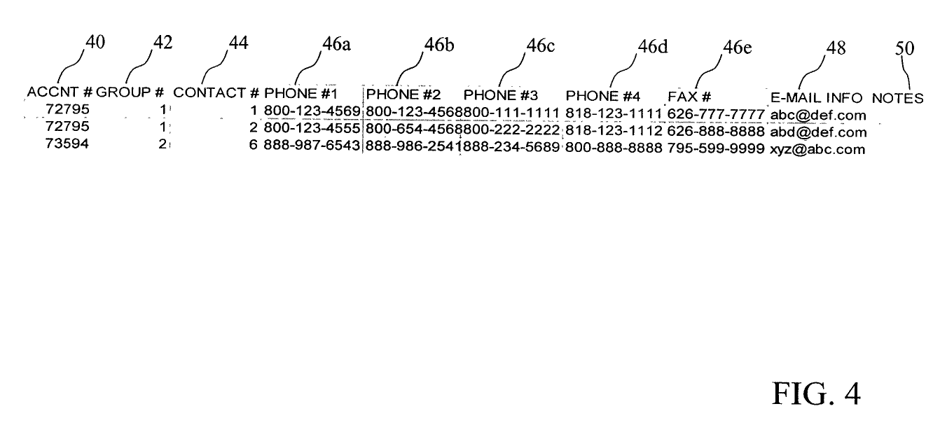

In order to create and store a family tree structured address book, a database is created that contains the required fields to store contact information. An exemplary database is shown in FIG. 4. As shown in FIG. 4, each contact in the address book is saved as a separate record in the database. Each record has a unique identifier that is composed of three fields. The first field 40, is an account number field that contains the account pre-paid telephone service account number. The second field 42, is a group number specifying the number of the user defined group that the contact resides in. The third field 44 is the contact number of the contact within the group that the contact resides in.

In addition to the three identifier fields, a contact record contains several telephone number fields 46a-e. The telephone numbers stored in the telephone number fields may be for traditional phone numbers, mobile phone numbers, pager numbers, and facsimile machine numbers. Additionally, the contact record contains an e-mail address field 48 that contains the e-mail address of the contact. In an additional embodiment, the contact record also contains a note field 50 for storing additional text or numerical information corresponding to notes that the user wishes to keep about the contact, such as a birthday of the contact.

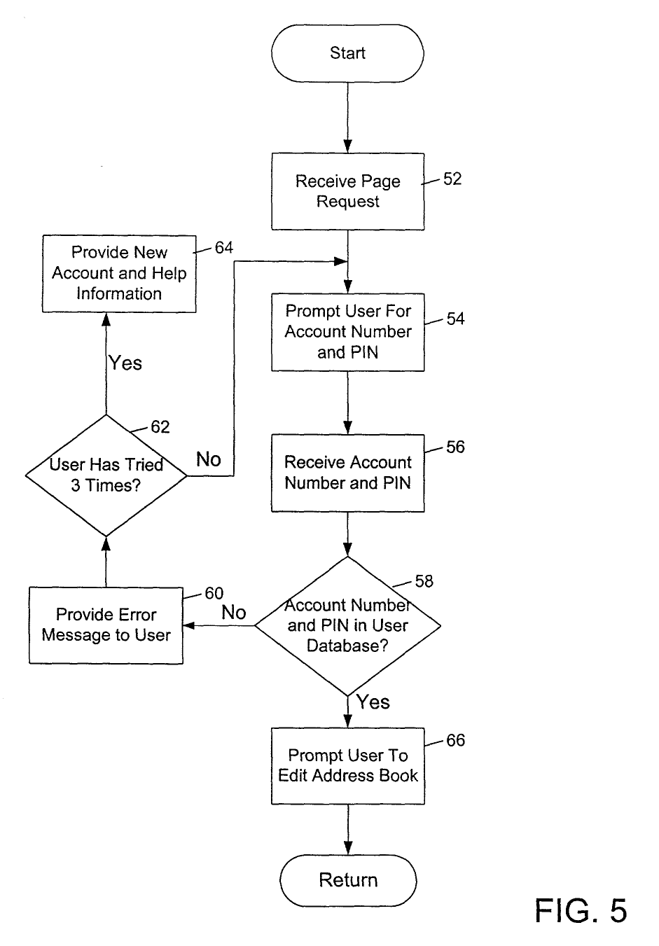

FIG. 5 shows a process for creating a new contact according to an exemplary embodiment. As shown in FIG. 5, the user contacts the server and requests a home page, box 52. The server sends the user a home page requesting that the user enter an account number and their PIN, box 54.

In an alternative embodiment, the user is also prompted to open an account by pressing a new account button. If the user presses the new account button, then the user is sent a series of screens prompting them to enter billing and credit card information. Once the user has successfully entered all of the necessary information the user is provided with an account number and a PIN code and returned to the home page.

Once the server receives an account number and a PIN from the user, box 56, the server checks in a database of registered users to see if the account number and PIN entered by the user correspond to a registered user, box 58. If the account number and PIN entered by the user do not correspond to a registered user, then the user is informed that the entered account number and PIN could not be found in the authorized user database, box 60.

The system then checks to see whether the user has attempted to enter a PIN three times, box 62. If the user has attempted to enter a PIN three times, then the user is provided with information on opening a new account and obtaining account access help, box 64. If the user has not attempted to enter a PIN three times, then an entry attempt counter is incremented by one and the user is prompted again to enter an account number and PIN.

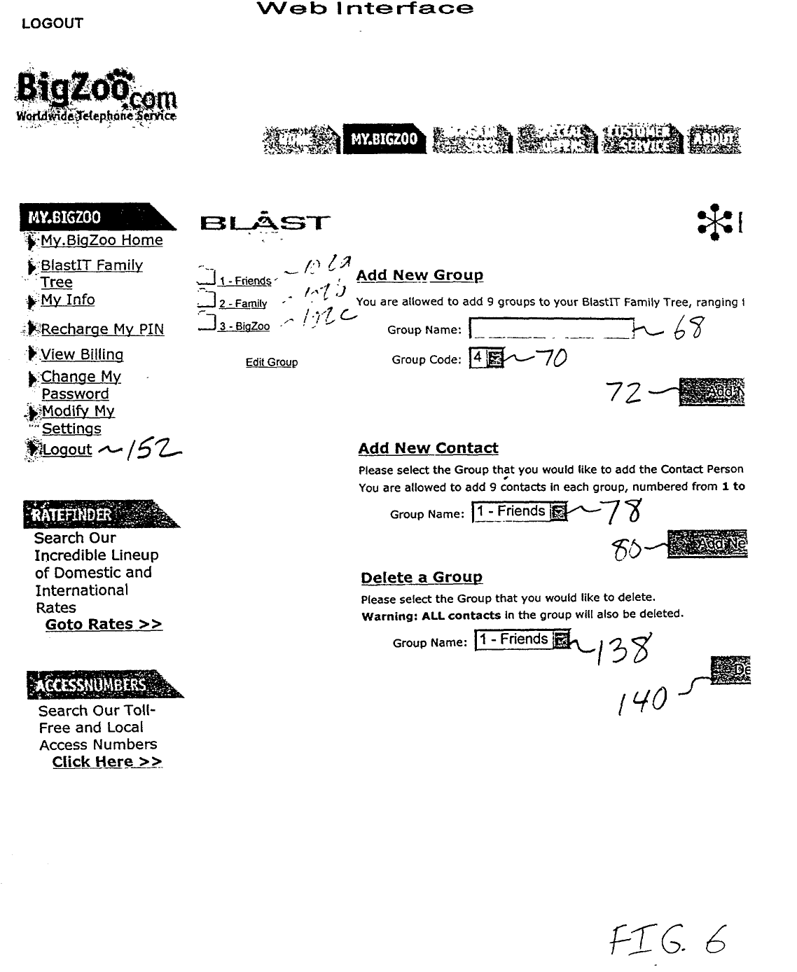

If the account number and PIN entered by the user correspond to a registered user, then the server sends the user an address book edit screen. Box 66. An example of an address book edit screen is shown in FIG. 6. The user is prompted to enter the name of a new group in a new group name entry box 68. The user is also prompted to select a number for the new group in a group number entry box 70. Once the user has entered a name and number for the new group the user presses an “add new group” button 72.

When a user presses the “add new group” button 72, the server checks to ensure that a group name and number have been entered by the user. If a new group name and number have not been entered by the user, then the server returns the user to the main address book edit screen. If a new group name and number have been added, then the new group name and number are stored in a database, and the user is shown a group addition screen.

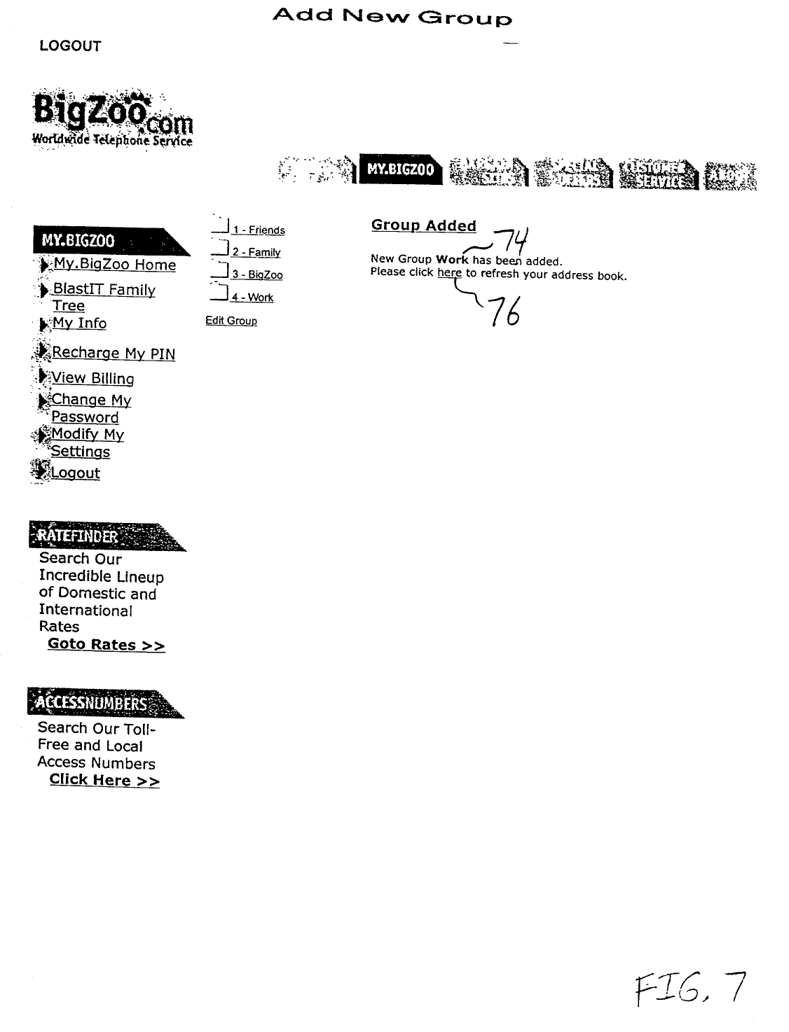

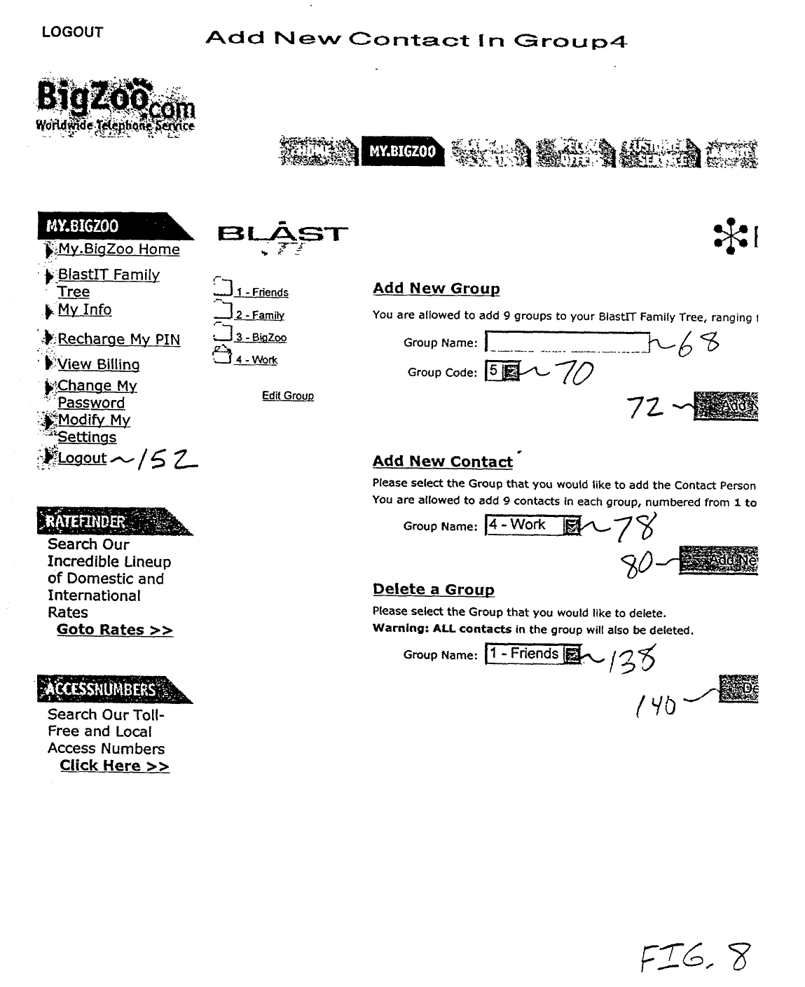

FIG. 7 is an exemplary group addition screen. The group addition screen points out the name 74 of the group that has been added. In an additional embodiment, the group addition screen points out the number of the group that has been created. The group addition screen prompts the user to return to the address book edit screen with the new folder visible for editing by selecting a hotlink 76. FIG. 8 is an address book edit screen showing the addition of a new group. Once a group is created, the user will be allowed to add contacts to the group.

As shown in FIGS. 6 and 8, the address book edit screen also prompts a user to enter a new contact within an already created group. In order to enter a new contact within an already created group, the user selects a group number and name from within the group selection pull-down menu 78. Once the user selects a group name and number from the pull-down menu 78, the user presses the “add new contact” button 80. If the user has not already created a group, then this option will not be available to a user at the address book edit screen.

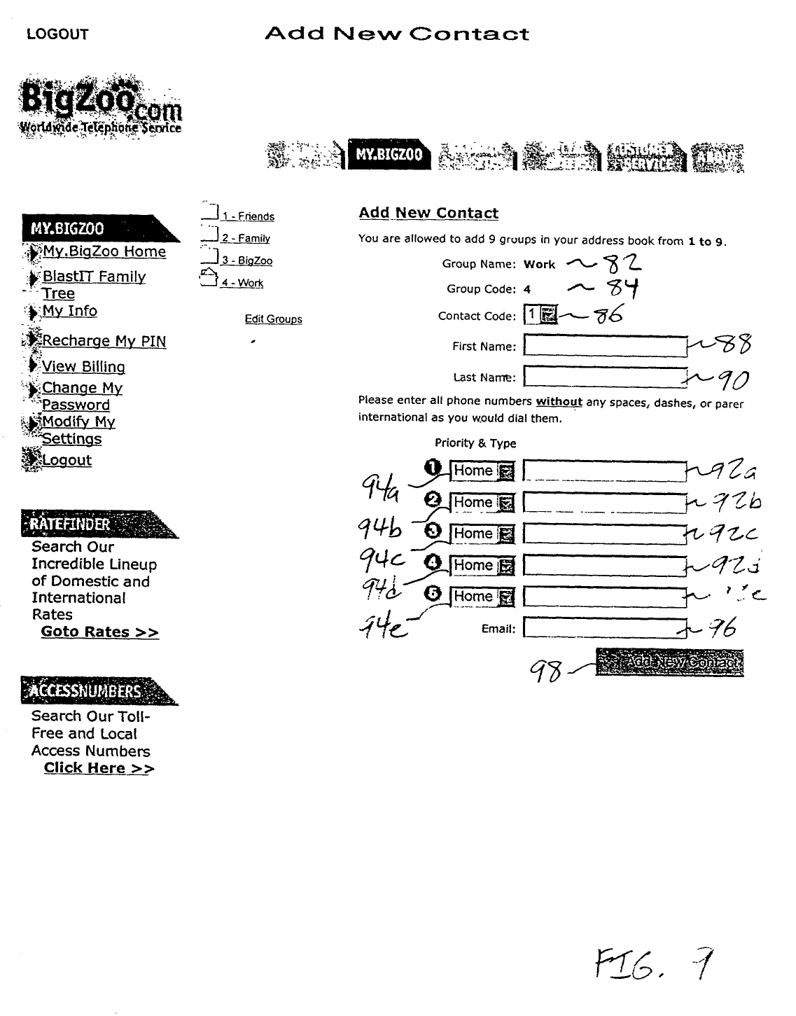

If the user presses the “add new contact” button, then the user is prompted to enter information about the new contact. A new contact entry screen according to an embodiment of the present invention is shown in FIG. 9. As shown in FIG. 9, the group name 82 and group number 84 for the contact is already filled in. The user is prompted to edit a contact number 86 for the contact within the group. The user is prompted to enter the first name of the contact in a first name entry box 88. The user is also prompted to enter the last name of the contact in a last name entry box 90.

The user is prompted to enter up to five different phone numbers for the contact in phone number entry boxes 92a-e. The user is prompted to select a phone number type for each number in phone number type entry boxes 94a-e, so that the user will later be able to easily recognize which number corresponds to which phone of the contact. In an embodiment, possible phone number types are placed in a pull down selection menu and include home, office, mobile, pager, and facsimile.

The user is also prompted to enter an e-mail address for the contact in an e-mail address entry box 96. As will be seen below, the entry of an e-mail address facilitates the sending of voice messages and multimedia messages to the contacts e-mail account. In an additional embodiment of the present invention, the user is prompted to enter additional e-mail addresses for the contact. In yet another additional embodiment, the user is prompted to enter notes into a note field, so that the user may store additional information about the contact, such as the contacts birthday.

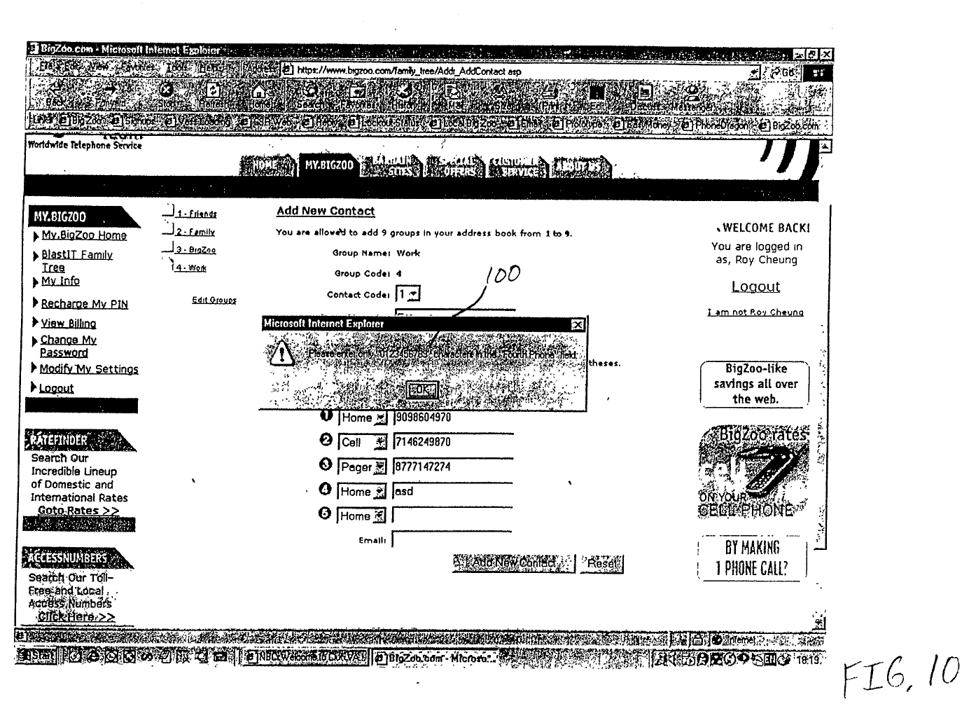

Once the user has finished entering the name, phone numbers and e-mail address for the contact, the user presses the “add new contact” button 98. The server attempts to verify the information entered by the user. In an embodiment, the system checks to see if a contact matching the first and last names entered has already been entered by the user. If a contact matching the first and last name has already been entered by the user, a duplication confirming screen is sent to the user notifying the user of the double entry and asking the user if they still wish to add the user. The number of digits of each phone number entered by the user is checked for validity. If any of the phone numbers entered by the user are invalid, then the user is returned to the add contact screen and prompted to fix the invalid phone number. FIG. 10 is a web page showing an error reentry prompt according to an embodiment. As seen in FIG. 10, the user is shown the correct telephone number format 100 and prompted to reenter the telephone number.

In an embodiment, in order to check for telephone number validity, the system checks the user entry, and if the entry contains non numeric characters or is less than a standard telephone number with area code, then the system assumes that the number is invalid.

In an alternative embodiment, the system checks the area code entered, in order to ensure that the area code is a valid area code. In yet another embodiment, the system checks the prefix entered to ensure that the prefix corresponds to a valid prefix within the area code entered by the user. In an additional embodiment, the system checks to ensure that the e-mail address entered is valid by contacting the e-mail server entered and checking to see if the recipient exists on the entered e-mail sever.

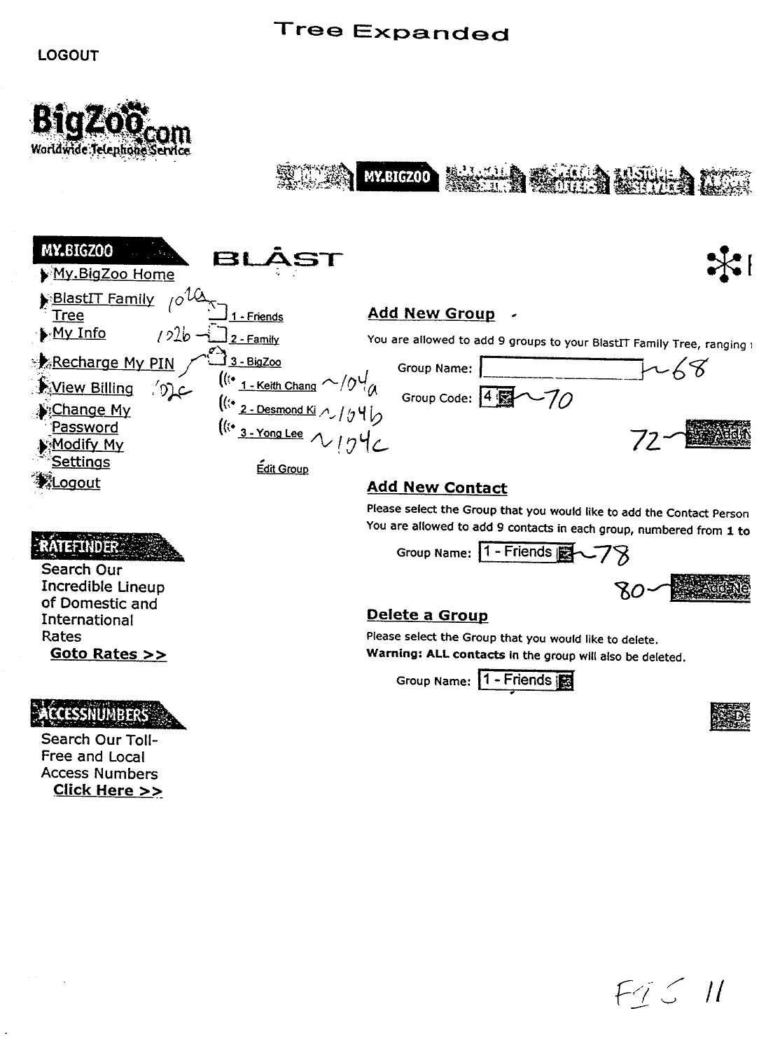

From the address book edit screen, a user may edit one of the groups already created by clicking their mouse on the folder of the group 102a-c, as shown in FIG. 6. Once the user clicks on a folder, the contacts 104a-c within the folder are displayed on the address book edit screen as shown in FIG. 11. If the user chooses to edit one of the contacts 104a-c displayed, then the user clicks their mouse on the contact. If the user clicks on one of the contacts, then the user is taken to a contact editing screen.

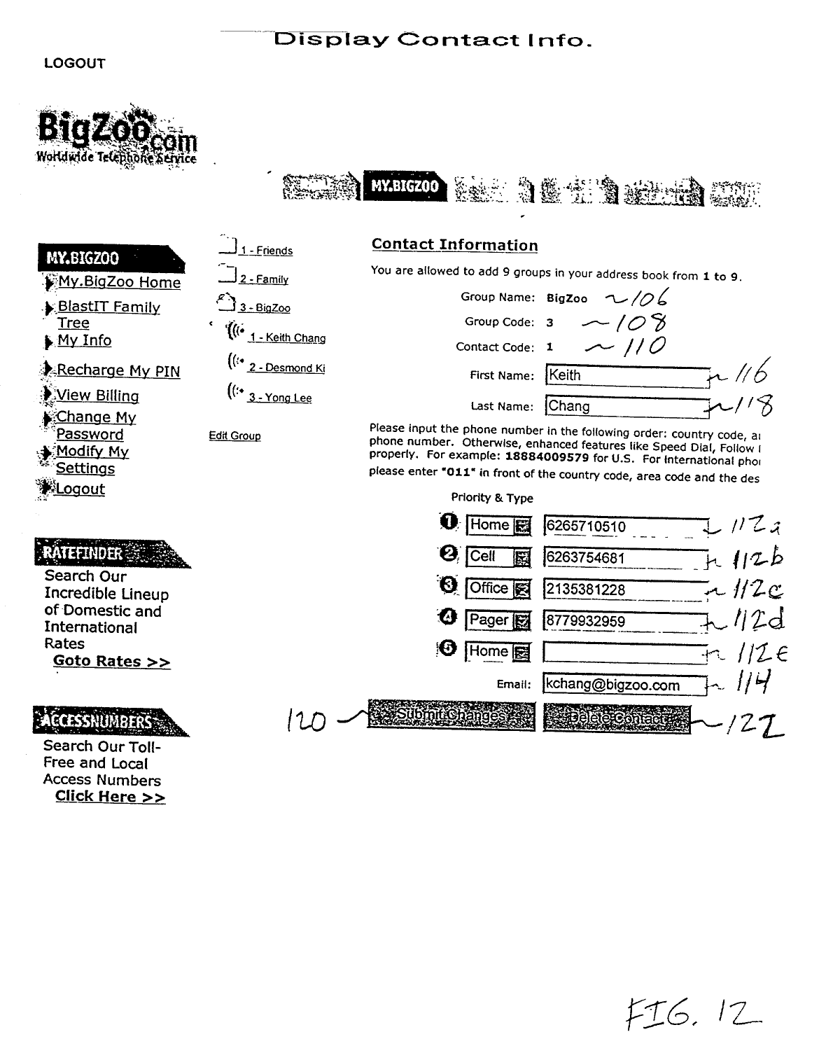

FIG. 12 is an example of a contact editing screen according to an embodiment of the present invention. As seen in FIG. 12, the server fills in the group name 106, group number 108 and contact number 110 of the contact. The server also fills in any entered telephone number 112a-e and e-mail address information 114.

The user is prompted to edit a first name 116 and a last name 118, as well as the telephone numbers 112a-e and e-mail address information 114. In an additional embodiment, the user is also prompted to change the group name 106, group number 108 and contact number 110 for the contact. Once the user finishes editing the contact information, the user presses the “submit changes” button 120. If the user presses the “submit changes” button 120, then the server validates the information entered as explained above for new contacts. The user may also choose to delete the contact by pressing the “delete contact” button 122.

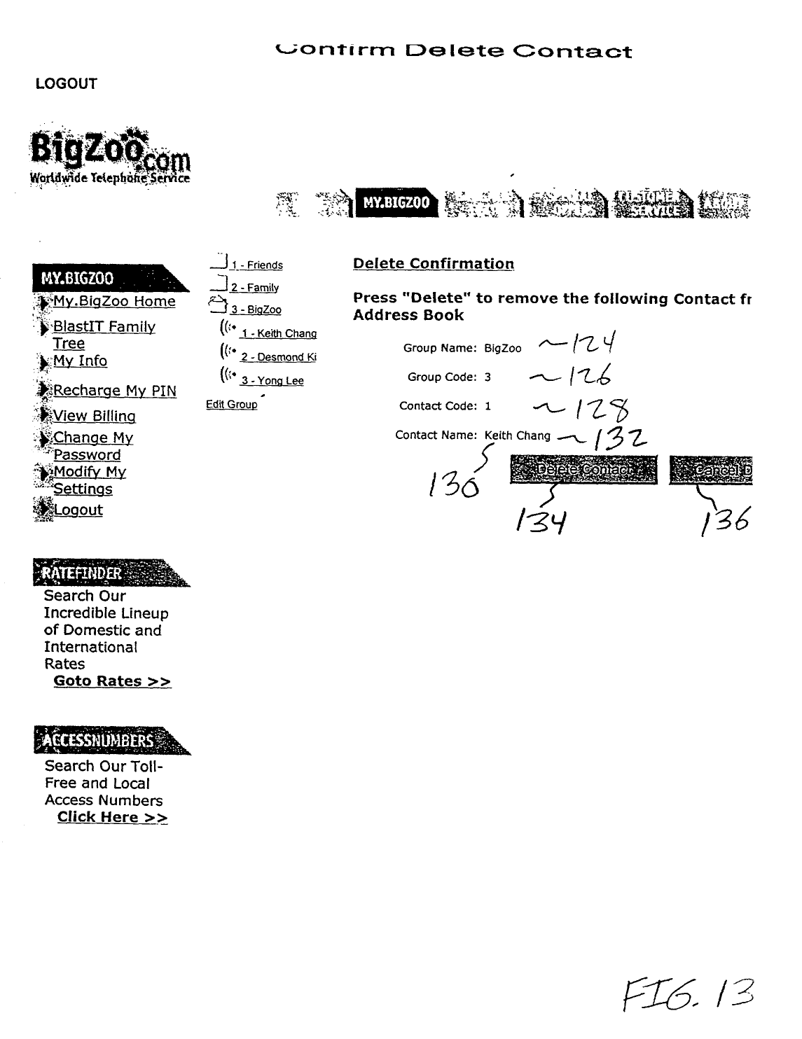

If the user presses the “delete contact” button 122, then the user is shown a delete contact confirmation screen as shown in FIG. 13. The delete contact confirmation screen displays the group name 124, the group code 126, the contact code 128, the first name 130, and the last name 132 of the contact, and prompts the user to either confirm the deletion or to cancel the deletion. If the user presses a “delete contact” button 134, then the deletion is completed and the record is erased from the database. Alternatively, if the user presses the “cancel deletion” button 136, then the user is returned to the contact edit screen.

If the user has already created at least one group, then the address book edit screen also prompts the user to delete a group of contacts. As shown in FIGS. 6 and 8, if the user elects to delete a group of contacts, then the user selects a group to delete from the group number and name from within the group deletion pull-down menu 138. Once the user selects a group name and number from the group deletion pull-down menu 138, the user presses a group delete button 140.

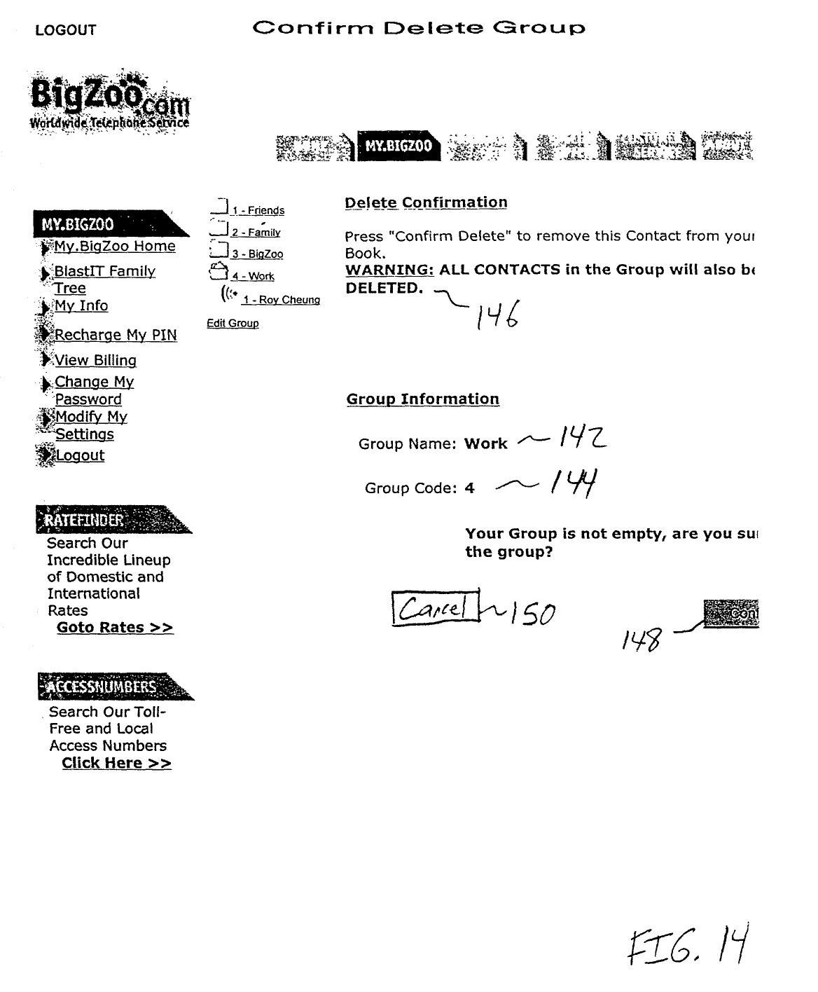

If the user presses the group delete button 140, the user is presented with a group deletion confirmation screen as shown in FIG. 14. The group deletion confirmation screen lists the group name 142 and the group number 144 selected by the user to be deleted and displays a warning 146 that all of the contacts within the group will be deleted if the user presses a confirm button 148. If the user presses the confirm button 148, then all of the records with the users account number and the selected group number are erased from the database. Alternatively, the user may press a group delete cancel button 150. If the user presses the group delete cancel button 150, then the group cancel command is negated and the user is returned to the edit address book screen.

As shown in FIGS. 6 and 8, the edit address book screen also contains a logout button 152. Once the user has finished entering and editing contact information, then the user logs out of the address book and is now able to access any of the entered contacts.

A user may access their address book entries using a telephone. Two applications using the address book will now be illustrated below, although other applications are also possible, from a telephone or from a computer or personal information appliance coupled to the Internet.

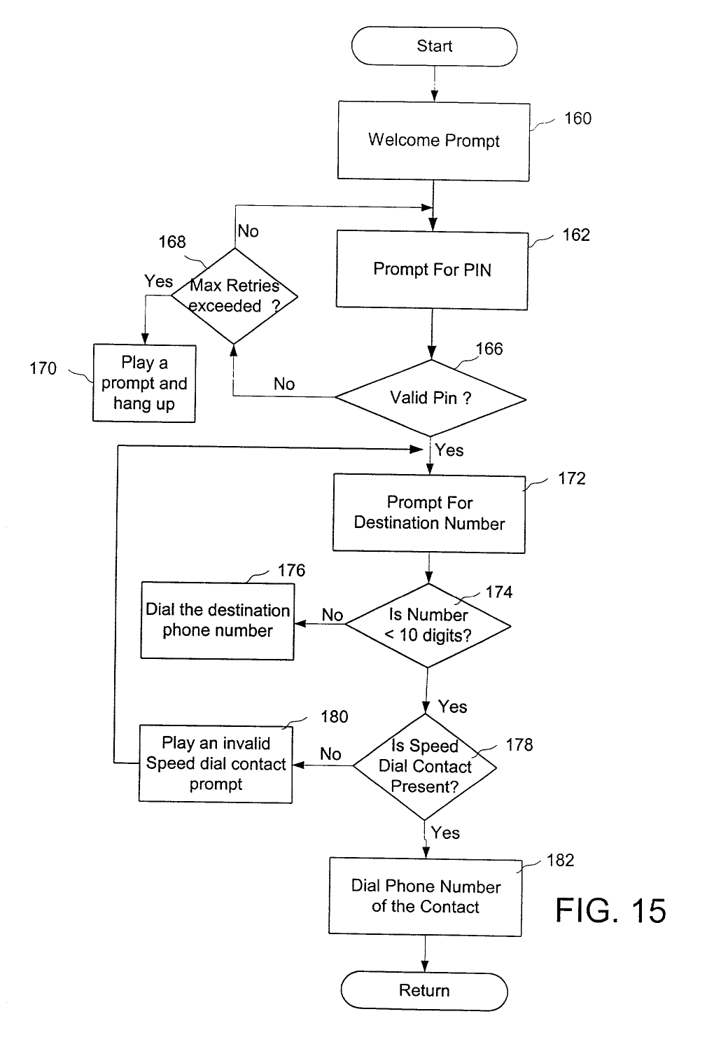

FIG. 15 is a flowchart of a system for speed dialing contacts that have been saved in the address book according to an embodiment. Speed dial is a way to speed up the dialing process of an online pre-paid phone service. Speed dial allows users to track down people who have multiple phone numbers without having to remember or look up each number. To use the Speed Dial feature, the user must first have at least one contact in his/her address book.

In order to use the speed dial system, a prepaid telephone service customer calls an access number to access the server. In an embodiment, the access number is a toll-free number that can be accessed from anywhere in the world. Upon dialing the access number, the user is played a welcome message, as shown in Box 160. The user is prompted to enter their PIN as shown in Box 162. In an embodiment, the user is prompted to enter a particular character upon finishing their PIN, such as the star “★” key or the pound sign “#”.

Upon receiving a PIN entry from a user, the system checks the authorized user database to see whether the PIN is valid as shown in Box 166. If the PIN is not found in the authorized user database, then the system checks to see how many times the user has attempted to enter a PIN as shown in Box 168. If the user has tried to enter a valid PIN more than a preselected number of times, then the user is played a message telling them to check their records for their correct PIN or to call a help line at a preselected number as shown in Box 170. If the user has not tried to enter a valid PIN more than a preselected number of times, then a counter of attempts is incremented to track the number of user attempts and the user is re-prompted to enter a PIN.

If the user enters a valid a PIN, then the user is prompted to enter telephone number to call, as shown in Box 172. In an embodiment, the user is prompted to enter a particular character upon finishing their entry of a telephone number, such as the star “★” key or the pound sign “#”. The telephone number entered by the user checked for length, as shown in Box 174. If the telephone number entered by the user is the normal length of a telephone number with area code, normally 10 digits, then the system dials the number entered by the user, as shown in Box 176.

If the telephone number entered by the user is less than the normal length of a telephone number with area code, normally 10 digits, then the system assumes that the use is intending to speed dial a contact from their address book. The system checks in the database to see if a database record corresponds to the account number of the user, as well a group and contact number corresponding to the number entered by the user, as shown in Box 178.

If the system does not find a database record corresponding to the account number of the user, as well as the entered group and contact numbers, then the user is played a message notifying them that no contact was found, as shown in Box 180, and prompted to enter a telephone number again. If the system does find a database record corresponding to the account of the user, as well as the entered group and contact numbers, then the server plays the first and last names of the contact from the database for the user using a voice synthesizer. The system then dials the first number for the contact saved in the database, as shown in Box 182. In an additional embodiment, the transaction is recorded on the user's online statement.

For example, if a user wants to speed dial the second person in the third group, the user only needs to punch in the number 3 to select the third group, followed by the number 2 to select the second person in the group. In an additional embodiment, if the user then presses the * key, then the first number listed under that contact will be retrieved from a database and the number will be dialed. In an alternative embodiment, if the user wishes to skip ahead to the next number for the contact saved in the database, the user only needs to press the * key again, and the system retrieves and dials the next available number from the database. In yet another embodiment, users are allowed to scroll through all of the numbers for a specific contact twice before they will be asked to enter a new telephone number.

In an alternative embodiment of a speed dial system, once the user has their PIN authenticated, the user is prompted to press the * key to use a voice prompted speed dial system, or to enter a telephone number for dialing. The server reads a list of the user's created group names and corresponding numbers to a user using voice synthesis software and prompts the user to select a group. Once the user has selected a group, the system reads a list of contacts within the selected group to the user, and prompts the user to select a contact number. Once the user selects a contact within the group, the server reads a list of telephone number types stored for the chosen contact, and prompts the user to select a number to dial. Once the user selects a number to dial, the system dials the number.

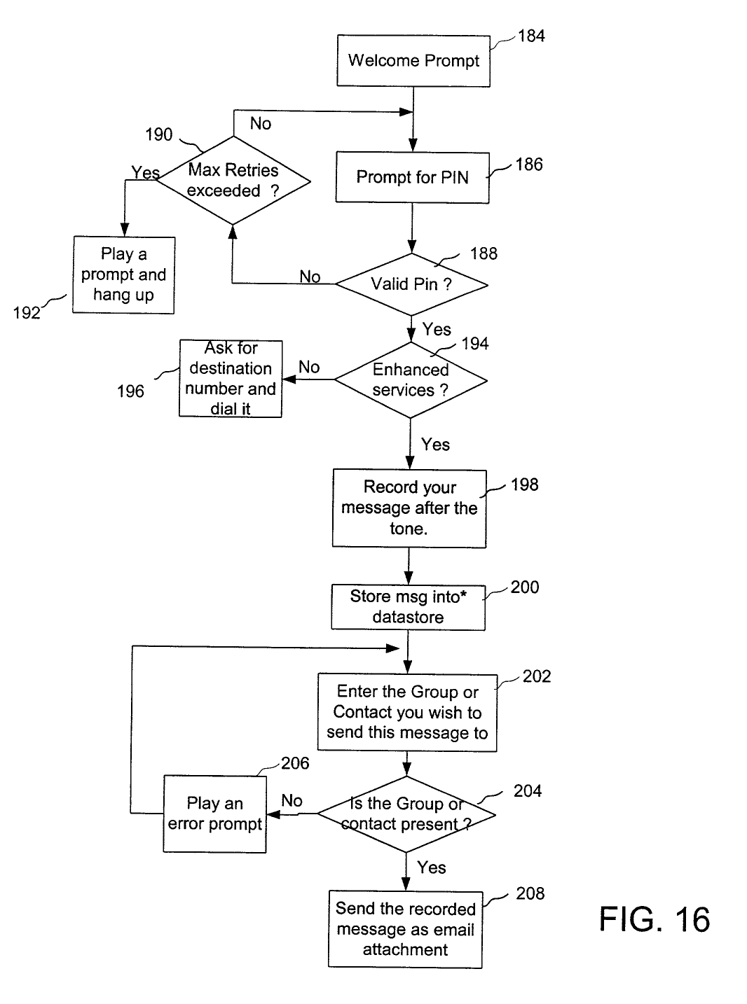

FIG. 16 is a flow chart for a voice message to e-mail application using a family tree structured address book according to an exemplary embodiment. Voice message to e-mail allows users to record a voice message over the phone and send it to one or more e-mail addresses as an e-mail attachment. The format of the voice message is stored in a format that can be played back by a standard media player computer program, such as RealPlayer or Microsoft Media Player.

As with the speed dial system above, a user calls an access number. Upon dialing the access number the user is played a welcome message as shown in Box 184. The user is prompted to enter their PIN as shown in Box 186. In an embodiment, the user is prompted to enter a particular character upon finishing their PIN, such as the star “★” key or the pound sign “#”.

Upon receiving a PIN entry from a user, the system checks the authorized user database to see whether the PIN is valid as shown in Box 188. If the PIN is not found in the authorized user database, then the system checks to see how many times the user has attempted to enter a PIN as shown in Box 190. If the user has tried to enter a valid PIN more than a preselected number of times, then the user is played a message telling them to check their records for their correct PIN or to call a help line at a preselected number as shown in Box 192. If the user has not tried to enter a valid PIN more than a preselected number of times, then a counter of attempts in incremented to track the number of user attempts and the user is re-prompted to enter a PIN.

If the user enters a valid a PIN, then the system prompts the user to leave a voice message via e-mail as shown in Box 194. If the user receives a response indicating the user does not wish to leave a voice message via e-mail then the user is prompted to enter a telephone number to dial as shown in Box 196. Upon receipt of a telephone number, the system dials it. In an alternative embodiment, the system may utilize the speed dial functionality at this point depending on the number entered by the user.

If the user elects to leave a voice message via e-mail, then the user is prompted to record a voice message as shown in Box 198. After the user finishes recording a voice message, the voice message is stored in a Database, as shown in Box 200 and is made available to a receiver as an e-mail attachment. In an embodiment, the voice message is appended to a stock e-mail as a file. In an alternative embodiment, the voice message is stored as a file on the server, and a stock e-mail is sent to a designated recipient. When the designated recipient opens their e-mail, the user's e-mail reader automatically contacts the server, retrieves the voice message file and plays the voice message for the recipient.

Users have the option to send the recorded message to one or more people in their online address book. The user is prompted to enter a group or contact to send the message to as shown in Box 202. In an exemplary embodiment, if the user wants to send the voice message to the second contact in the third group, they just need to punch in 3 followed by a 2 followed by a ★. Users also have another option to send a voice message to an entire group or the entire family tree structure (all contacts in the Family Tree). For example, to send a message to everyone in Group 2, instead of entering all of the contact codes, the user just enters 2 and then 0. Then the system will send an e-mail with the file attachment to everyone that belongs to Group 2 who has a valid e-mail.

Upon receipt of group or contact entry from the user, the system checks to see whether the group or contact is in the database as shown in Box 204. If the user has selected a contact, the system checks for database records having the user's account number, and the entered group and contact numbers. If the user has selected a group, then the system checks for database records having the user's account number and the entered group number.

If the system finds a group or contact, then the system checks to see if there is a valid e-mail address saved for the contact. If the system is unable to find any records corresponding to the group or contact information entered by the user, or if there is no e-mail address saved for the found contacts, then the system plays an error message for the user. The error message indicates that no group or contacts matching the entered information were found as shown in Box 206. The system then re-prompts the user to enter a group or contact.

If the system finds a valid contact or group of contacts, with a valid e-mail address, then the system sends an e-mail message with the voice message to the one or more contacts as shown in Box 208. In an additional embodiment, a confirmation e-mail is sent to the user and a transaction is recorded on the user's online statement.

In an alternative embodiment of the present invention, a user may enter a video clip to be sent via e-mail. In this embodiment, a user using a telephone equipped with a video camera records a video, instead of an audio message. The video is sent to a contact in an analogous manner as an audio message.

In yet another embodiment of the present invention, a user is prompted to send a transcript of an audio message to a fax number of one or more contacts. In this embodiment, the user is prompted to enter a voice message. Upon receipt of the voice message, the server converts the voice message into text using speech to text conversion software such as Via Voice by IBM. Once the message has been converted into text, the text is converted into a facsimile format and is sent to the facsimile number saved for the one or more contacts selected by a user. In another embodiment, instead of the text of a voice message being sent to a fax machine, the text is sent as an e-mail to the e-mail address of the one or more contacts selected by a user.

Although an exemplary embodiment of the present invention has been described, it should not be construed to limit the scope of the appended claims. Those skilled in the art will understand that various modifications may be made to the described embodiment. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

What is claimed is:

1. A method for storing contact information comprising the steps of:
storing in a database information about a plurality of groups;
storing in a database information about a contact that is a member of at least one of the plurality of groups;
linking the stored information about a contact to at least one of the plurality of groups;
receiving a request for stored information about a contact from a user;
providing stored information about a contact in response to the request for stored information about a contact.

2. The method for storing contact information of claim 1 wherein the step of storing information about a plurality of groups further comprises:
storing a group name for each of the plurality of groups; and
storing a group number for each of the plurality of groups.

3. The method for storing contact information of claim 2 wherein the step of storing information about a contact further comprises:
storing a group number of which the contact is a member;
storing a contact number for the contact; and
storing at least one of the group consisting of a telephone number and an e-mail address.

4. The method for storing contact information of claim 2 wherein the step of storing information about a contact further comprises:
storing a group number of which the contact is a member;
storing a contact number for the contact;
storing a plurality of telephone numbers for the contact; and
storing an e-mail address for the contact.

5. The method for storing contact information of claim 1 wherein the step of receiving a request for stored information further comprises:
receiving a group identification from a user; and
receiving a contact identification of the desired contact from a user.

6. The method for storing contact information of claim 5 wherein the step of providing stored information further comprises:
searching the database for a contact having the received group number;
searching the database for a contact having the received contact number; and
providing at least one of the group consisting of a telephone number and an e-mail address for a contact found in the database having the received group number and the received contact number.

7. The method for storing contact information of claim 6 further comprising connecting by telephone the user and a contact.

8. The method for storing contact information of claim 6 further comprising:
receiving from the user an audio message; and
sending the received audio message to a contact by e-mail.

9. The method for storing contact information of claim 6 further comprising:
receiving from the user a video message; and
sending the received video message to a contact by e-mail.

10. A method for storing contact information comprising the steps of:
authenticating a user;
receiving group information from a user;
receiving contact information from a user;
storing group information and contact information received from a user in a database;
receiving a telephonic request from a user for contact information; and
providing contact information to a user.

11. The method for storing contact information of claim 10 wherein the step of receiving group information from a user further comprises the steps of:
receiving a group name from a user; and
receiving a group number from a user.

12. The method for storing contact information of claim 11 wherein the step of receiving contact information further comprises the steps of:
receiving a group number from the user, the group number defining the group that the contact is a member of;
receiving a contact name from a user;
receiving a contact number from a user; and
receiving at least one of the group consisting of a telephone number and an e-mail address from a user.

13. The method for storing contact information of claim 12 further comprising retrievably storing the received contact information in a database, the information being retrievable based upon authenticated user information, the group number received, and the contact number received.

14. The method for storing contact information of claim 13 wherein the step of receiving a request for contact information further comprises the steps of:
receiving a group number from a user; and
receiving a contact number from a user.

15. The method for storing contact information of claim 14 wherein the step of providing contact information to a user further comprises:
searching a database for records containing the authenticated user information, the received group number and the received contact number;
retrieving contact information from the database; and
using the stored contact information to initiate telephonic communication between the user and the requested contact.

16. A system for storing contact information for a user comprising:
a database coupled to a computer network for storing information about at least one group and about at least one contact within the at least one group;
a server coupled to the computer network, configured to receive group information from a user, receive contact information from the user, and to store the group information and the contact information received from the user in the database;
a telephone connected to a telecommunications network for communicating with a contact, the telephone being coupled to the server through the telecommunications network;
wherein the server is further configured to receive a request for contact information from the user using a telephone and to provide the user with contact information.

17. The system for storing contact information of claim 16 wherein the server is further configured to arrange a telephonic link between a user on the telephone and a contact in response to a user request for contact information.

18. The system for storing contact information of claim 17 wherein the server is further configured to receive an audio message from the user; and to send the audio message to a contact over the computer network through e-mail information stored for the contact.

19. A computerized method for storing contact information comprising the steps of:
storing a group number for at least one group;
storing a group number and a contact number for a contact;
receiving from a user a selection of a contact, the selection containing a group number and a contact number;
connecting the user to the selected contact by telephone.

20. A computer readable medium having stored thereon a set of instructions including instructions for storing contact information, the instructions, when executed by a microprocessor, cause the microprocessor to perform the steps of:
prompting a user to enter a group name;
receiving from the user a group name;
prompting the user to enter a group number;
receiving from the user a group number;
prompting the user to enter a group number for a contact;
receiving from the user a group number for a contact;
prompting the user to enter a contact number for the contact;
receiving from the user a contact number for the contact;
prompting the user to enter contact information;
receiving from the user contact information;
storing the group number, the contact number, and the contact information in a database;
prompting the user to enter a group number and a contact number of a contact the user wishes to contact;
receiving from the user a group number and a contact number of a contact;
searching the database for a contact having contact information corresponding to the group number and the contact number; and
connecting the user to the found contact.
